(19) United States
(12) Patent Application Publication
(10) Pub. No.: US 2025/0377065 A1
(43) Pub. Date: Dec. 11, 2025

(54) Pipe Leak Remediating Device

(71) Applicant: Robert Collier, Oakland, CA (US)

(72) Inventor: Robert Collier, Oakland, CA (US)

(21) Appl. No.: 19/085,168

(22) Filed: Mar. 20, 2025

Related U.S. Application Data
(60) Provisional application No. 63/658,475, filed on Jun. 11, 2024.

(51) Int. Cl. F16L 55/178; F16L 55/07; F16L 101/60

(52) U.S. Cl. CPC F16L 55/178; F16L 55/07; F16L 2101/60

(57) ABSTRACT

A leak remediating device is disclosed that catches and redirects/diverts water from leaking pipes, faucets, and/or P-traps to a drain with an attached water hose. The device comprises a top body component or portion, a bottom body component or portion comprising a drain component and gasket component, hook and latch fasteners, and a water hose attachment. The device can be attached directly to a pipe or faucet using hook and latch fasteners and optional nylon straps. Additionally, the device provides a solution for leaks on the top or sides of a pipe by creating a complete seal around the pipe when the device is secured and in use. Further, the device is available in a plurality of sizes to meet the needs of all pipes and leaks.

### CROSS-REFERENCE TO RELATED APPLICATION

The present application claims priority to, and the benefit of, U.S. Provisional Application No. 63/658,475, which was filed on Jun. 11, 2024, and is incorporated herein by reference in its entirety.

### FIELD OF THE INVENTION

The present invention relates generally to the field of plumbing devices. More specifically, the present invention relates to an improved pipe leak device that that catches water from leaking pipes and directs the water to a drain with an attached hose. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in pipe leak devices. Generally, when pipe leaks are discovered, buckets and pots are placed under the leak to prevent the water from accumulating on the floor until the pipe is repaired. A significant strain is placed on the homeowner to repair the pipe to prevent damage to possessions and the home. Further, homeowners may be at risk for additional costs if the repair is not made in a timely manner.

Additionally, water leaks can cause massive damage to a home or building, which can lead to sagging or collapsing floors, walls, and ceilings, if the leak is not repaired in a timely fashion. At such time an immediate repair is not possible which can cause mildew, mold, and fungus within the area. Further, it may not be practical or possible to turn the water supply off, thereby continuing the leak until a permanent repair is made.

Accordingly, there is a demand for an improved leak ‘buddy’ device that provides for redirecting leaking water to an appropriate location. More particularly, there is a demand for a leak ‘buddy’ device that prevents damage to homes or buildings along with possessions within the building by redirecting water from leaking pipes to an appropriate floor or sink (i.e., utility) drain. Further continuance of a leak may lead to additional, unexpected expenses for the resident with replacing possessions and completing the repairs.

Therefore, there exists a long felt need in the art for a leak ‘buddy’ device that provides a device that attaches to a leaking pipe or faucet to collect water and redirect the water to a drain using a hose attachment. There is also a long felt need in the art for a leak ‘buddy’ device that offers residents additional time to schedule a plumber to make the repair (i.e., permanent repair to the pipe). Moreover, there is a long felt need in the art for a leak ‘buddy’ device that offers residents an additional, semi-permanent solution to a leaking pipe. Further, there is a long felt need in the art for a leak ‘buddy’ device that saves users money by avoiding replacing personal possessions due to water damage. Finally, there is a long felt need in the art for a leak ‘buddy’ device that saves residents money by obviating remediation of mold, mildew, and fungus.

The subject matter disclosed and claimed herein, in one embodiment thereof, comprises a leak ‘buddy’ device. The device is a plastic apparatus that catches water from leaking pipes and/or P-traps and directs the water to a drain with an attached water hose. The leak ‘buddy’ device comprises a top body component or portion that wraps around the pipe and attaches to the bottom body component or portion. Further, the gasket component and drain component are secured to the bottom body component or portion. Additionally, the hook and latch components secure the top body component or portion and bottom body component or portion to the desired location on the leaking pipe. The gasket component creates a seal around the device. Further, the drain component can be attached to a water hose attachment. The water hose attachment enables the user to redirect leaking water to a drain. Accordingly, the device offers residents a fast, easy, and effective method for fixing or remediating a leak.

In this manner, the leak ‘buddy’ device of the present invention accomplishes all of the forgoing objectives and provides users with a device that redirects leaking water to a drain. The device is a leak ‘buddy’ device is an attachment that is secured around a leaking pipe or faucet that collects leaking water. The device can redirect the water to a drain using a hose attachment.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a leak ‘buddy’ device. The device is an apparatus that catches water from leaking pipes, faucets, and/or P-traps and directs or diverts water to a drain with a water hose attachment. The leak ‘buddy’ device comprises a top body component or portion that wraps around the pipe and attaches to the bottom body component or portion. Further, the gasket component and drain component are secured to the bottom body component or portion. Additionally, the hook and latch components secure the top body component or portion and bottom body component or portion to the desired location on the leaking pipe. The gasket component creates a seal around the device thereby preventing a puddle of water resulting from a leak therefrom. Further, the drain component can be attached to a water hose attachment. The water hose attachment enables the user to redirect leaking water to a drain. Accordingly, the device offers residents a fast, easy, and effective method for fixing with a leak.

In one embodiment, the leak ‘buddy’ device is made up, at a minimum, of the following components: a top body component or portion, a bottom body component or portion comprising a gasket component and drain component, a hook and latch fastener, and a water hose attachment to drain the leaking water. Optional items may be added to create additional functionality or increase safety, as needed.

In one embodiment, the top body component or portion and bottom body component or portion are formed of an enclosed, durable plastic case. In most instances, the top body component or portion and bottom body component or portion close together to form a rectangular casing around the pipe. The top body component or portion and bottom body component or portion create a cylindrical opening to enable the leaking pipe to run through the device. The top body component or portion and bottom body component or portion has dimensions such that it will fit around a standard pipe.

In one embodiment, the top body component or portion and the bottom body component or portion comprise a hook and latch component. The hook and latch component enables the device to become secure around the leaking pipe. Further, the bottom body component or portion comprises a gasket component and drain component. The rubber gasket component creates a complete seal between the top body component or portion and bottom body component or portion. Typically, the device can withstand 150 PSI and up to 250 degrees of heat or steam.

In one embodiment, all portions of the present inventions are fully enclosed and able to be quickly and easily wiped down and disinfected to prevent mold or mildew build up from the leaking water.

In one embodiment, a method of redirecting water from a leaking pipe to an appropriate floor or sink (i.e., utility) drain location is disclosed. The method includes the steps of providing a leak ‘buddy’ device comprising a top body component or portion, bottom body component or portion comprising gasket component and drain component, a hook and latch fastener, and a water hose attachment. The method also comprises placing the top body component or portion around the top of the leaking pipe. Further, the method comprises securing the bottom body component or portion to the top body component or portion around the pipe using the hook and latch fastener. The method also comprises attaching the water hose attachment to the drain component comprises on the bottom body component or portion. Finally, the method also comprises directing the water hose attachment to the desired floor or sink drain (i.e., utility drain) to provide puddling water.

Accordingly, the leak ‘buddy’ device of the present invention is particularly advantageous as it provides a device that offers a fast, easy, and effective method for correcting a leaking pipe. More specifically, that attaches to a leaking pipe or faucet to collect water and redirect water to a drain using a hose attachment. Furthermore, the device saves users money on water damage caused by leaking pipes like mold, mildew, and fungus. Additionally, the device can be universally applied to any standard size water pipe while providing residents with both a temporary and semi-permanent solution. In this manner, the leak ‘buddy’ device provides a universal solution to leaking pipes.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the leak ‘buddy’ device of the present invention in accordance with the disclosed architecture;

FIG. 2 illustrates a perspective view of one embodiment of the leak ‘buddy’ device secured on a leaking pipe of the present invention in accordance with the disclosed architecture;

FIG. 3 illustrates a perspective view of one embodiment of the leak ‘buddy’ device redirecting water from a leaking pipe using the hose attachment of the present invention in accordance with the disclosed architecture;

FIG. 4 illustrates a flowchart showing the method of collecting and redirecting water from a leaking pipe in accordance with the disclosed architecture;

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a leak ‘buddy’ device that provides a device that attaches to a leaking pipe or faucet to collect water and redirect the water to a drain using a hose attachment. There is also a long felt need in the art for a leak ‘buddy’ device that offers residents additional time to schedule a plumber to make the repair. Moreover, there is a long felt need in the art for a leak ‘buddy’ device that offers residents an additional, semi-permanent solution to a leaking pipe. Further, there is a long felt need in the art for a leak ‘buddy’ device that saves users money by avoiding replacement of personal possessions due to water damage. Finally, there is a long felt need in the art for a leak ‘buddy’ device that saves residents money by obviating remediation of mold, mildew, and fungus.

The present invention, in one exemplary embodiment, is a novel leak ‘buddy’ device. The device is an apparatus that catches water from leaking pipes, faucets, and/or P-traps and directs or diverts water to a drain with a water hose attachment. The leak ‘buddy’ device comprises a top body component or portion that wraps around the pipe and attaches to the bottom body component or portion. Further, the gasket component and drain component are secured to the bottom body component or portion. Additionally, the hook and latch components secure the top body component or portion and bottom body component or portion to the desired location on the leaking pipe. The gasket component creates a seal around the device. Further, the drain component can be attached to a water hose attachment. The water hose attachment enables the user to redirect leaking water to a drain. Accordingly, the device offers residents a fast, easy, and effective method for fixing or remediating a leak.

In one embodiment, the leak ‘buddy’ device is made up, at a minimum, of the following components: a top body component or portion, a bottom body component or portion comprising a gasket component and drain component, a hook and latch fastener, and a water hose attachment to drain the leaking water. Optional items may be added to create additional functionality or increase safety, as needed.

More specifically, the top body component or portion and bottom body component or portion are formed of an enclosed, durable plastic case. In most instances, the top body component or portion and bottom body component or portion close together to form a rectangular casing around the pipe. The top body component or portion and bottom body component or portion create a cylindrical opening to enable the leaking pipe to run through the device. Additionally, the top body component or portion and the bottom body component or portion comprise a hook and latch component. The hook and latch component enables the device to become secure around the leaking pipe. Further, the bottom body component or portion comprises a gasket component and drain component. During use, the rubber gasket component creates a complete seal around the device. As a result, the seal created by the gasket enables the device to withstand 150 PSI and up to 250 degrees of heat or steam.

The present invention is also comprised of a method of using the device. First a device is provided comprising a top body component or portion, bottom body component or portion comprising gasket component and drain component, a hook and latch fastener, and a water hose attachment. Then, the top body component or portion is positioned around the top of the leaking pipe. Then, the bottom body component or portion is secured to the top body component or portion around the pipe using the hook and latch fastener. Then, the water hose attachment is attached to the drain component comprises on the bottom body component or portion. Finally, the water hose attachment is used to direct the leaking water to the desired floor or sink drain (i.e., utility drain) to prevent puddling water.

Accordingly, the leak ‘buddy’ device of the present invention is particularly advantageous as it provides a device that offers a fast, easy, and effective method for correcting a leaking pipe. More specifically, that attaches to a leaking pipe or faucet to collect water and redirect water to a drain using a hose attachment. Furthermore, the device saves users money on water damage caused by leaking pipes, for example, damage due to mold, mildew, and fungus. Additionally, the device can be universally applied to any standard size water pipe while providing residents with both a temporary and semi-permanent solution. In this manner, the leak ‘buddy’ device provides a universal solution to leaking pipes.

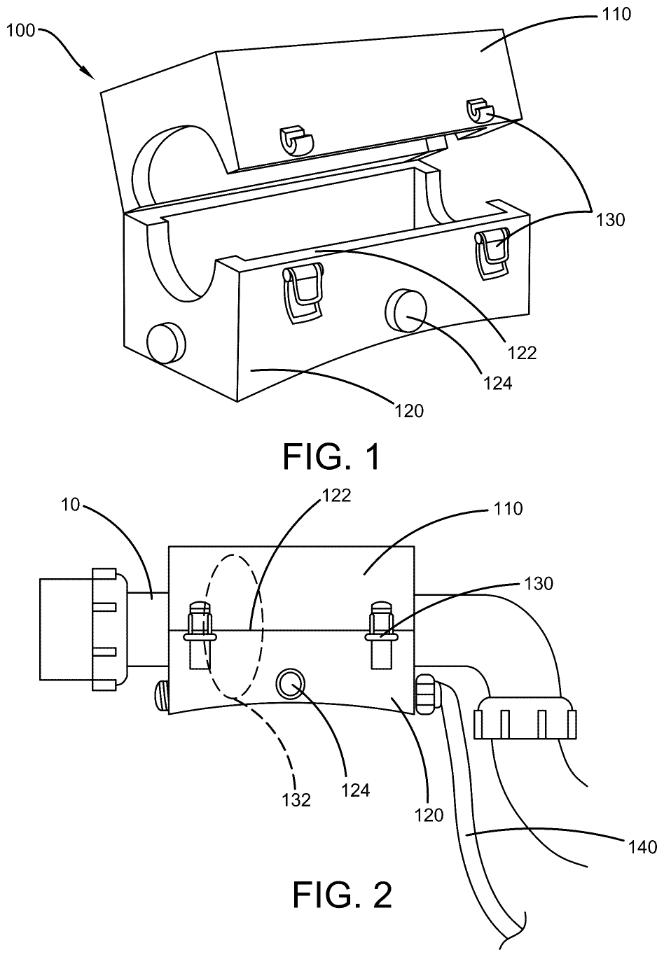

Referring initially to the drawings, FIG. 1 illustrates a perspective view of one embodiment of the leak ‘buddy’ device 100 of the present invention. In the present embodiment, the leak ‘buddy’ device 100 is an apparatus that catches water from leaking pipes, faucets, and/or P-traps and directs the waters to a drain with an attached water hose 140. Specifically, the leak ‘buddy’ device 100 comprises a top body component or portion 110, a bottom body component or portion 120 with an attached gasket component 122 and at least one bottom body drain component 124, at least one hook and latch fastener 130, and at least one water hose attachment 140. The top body component or portion 110 and bottom body component or portion 120 create a cylindrical opening to enable the leaking pipe 10 to run through the device 100. The top body component or portion 110 and bottom body component or portion 120 comprise dimensions such that it will fit around a standard pipe. Accordingly, the device 100 provides temporary and semi-permanent solutions for leaking pipes 10.

Generally, the leak ‘buddy’ device 100 is made up, at a minimum, of the following components: a top body component or portion 110, a bottom body component or portion 120, at least one gasket component 122 to seal the device 100 around the leaking pipe 10, at least one bottom body drain component 124 to redirect leaking water, and at least one hook and latch fastener to secure the device 100 to the leaking pipe 10. Optional items may be added to create additional functionality or increase safety as needed.

As shown in FIG. 2, the top body component or portion 110 and bottom body component or portion 120 is most often made of a durable plastic material that can withstand high water pressure and temperatures. Specifically, the device 100 can typically withstand 150 PSI and water/steam up to 250 degrees Fahrenheit. Generally, the device 100 is in the form of a rectangular prism with a cylindrical opening to house the leaking pipe 10. The top body component or portion 110 and bottom body component or portion 120 comprise dimensions such that it will fit around a standard water pipe within a residential building.

Additionally, a gasket component 122 lines the edges of the top body component or portion 110 and the edges of the bottom body component or portion 120 to create a complete seal around the opening of the device 100 and around the leaking pipe 10. Furthermore, the gasket component 122 is made from a rubber material, or other material known in the art, that is water-resistant. In one embodiment, the device 100 comprises at least one hook and latch component 130 to secure the device 100 to the leaking pipe 10. Moreover, the hook and latch component 130 secures the gasket component 122 around the rim of the device 100 when locked or latched. The hook and latch component 130 is preferably a metal lock mechanism or any other suitable fastener known in the art.

In another embodiment, the device 100 comprises at least one nylon strap (i.e., nylon hook and loop strap) 132. Further, at least one nylon strap 132 may be used to provide additional stability when the device 100 is in use. Additionally, the nylon strap 132 is preferably made from a durable nylon material. At least one nylon strap 132 may be wrapped around the device 100 or enable the device 100 to be hung while in use.

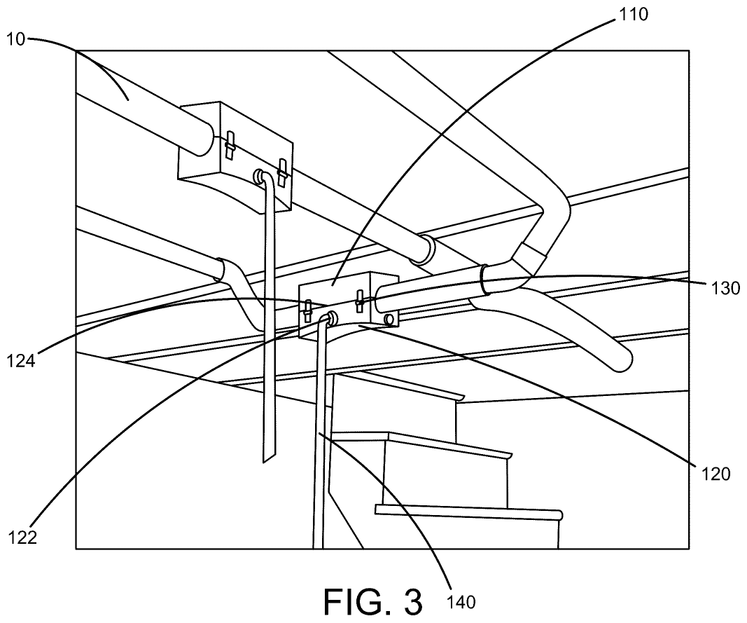

As shown in FIG. 3, the device 100 redirects or diverts water from a leaking pipe 10 using the water hose attachment 140 of the present invention. Furthermore, the water hose attachment 140 directs or diverts water from the leaking pipe 10 and the device 100 to an appropriate floor or sink (i.e., utility) drain. The water hose attachment 140 is typically a standard ¾ inch thread but can be any size as is known in the art. Additionally, the water hose attachment 140 is typically made of vinyl, polyurethane, rubber, or metal or from any material as known in the art.

Further, the device 100 provides a quick and efficient way to help residents repair or remediate a leaking pipe 10. Moreover, the device 100 provides a temporary solution until a repair can be completed. In another embodiment, the device 100 provides a semi-permanent solution to water from a leaking pipe 10.

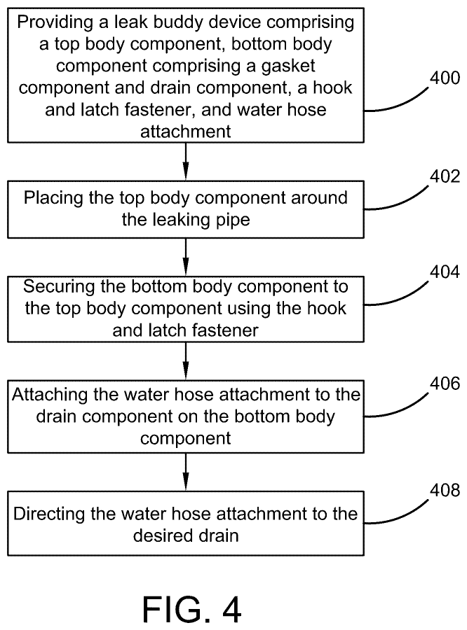

FIG. 4 illustrates a flowchart of the method of catching and redirecting water from leaking pipes 10. The method includes steps of 400, providing a leak ‘buddy’ device 100 comprising a top body component or portion 110, bottom body component or portion 120 including a gasket component 122 and a bottom body drain component 124, a hook and latch fastener 130 and a water hose attachment 140. The method also comprises at 402, placing the top body component or portion 110 around the leaking pipe 10. Further, the method comprises at 404, securing the bottom body component or portion 120 to the top body component or portion 110 using the hook and latch fastener 130. The method also comprises at 406, attaching the water hose attachment 140 to the bottom body drain component 124 on the bottom body component or portion 120. Finally, the method comprises at 408, directing the water hose attachment 140 to the desired floor or sink drain (i.e., utility drain).

Certain terms are used throughout the following description and claims to refer to particular features or components. As one skilled in the art will appreciate, different users may refer to the same feature or component by different names. This document does not intend to distinguish between components or features that differ in name but not structure or function. As used herein “leak ‘buddy’ device”, “leaking pipe device”, and “device” are interchangeable and refer to the leak ‘buddy’ device 100 of the present invention.

Notwithstanding the forgoing, the heated ceiling fan device 100 of the present invention can be of any suitable size and configuration as is known in the art without affecting the overall concept of the invention, provided that it accomplishes the above stated objectives. One of ordinary skill in the art will appreciate that the leak ‘buddy’ device 100 as shown in FIGS. 1-4 is for illustrative purposes only, and that many other sizes and shapes of the leak ‘buddy’ device 100 are well within the scope of the present disclosure. Although the dimensions of the leak ‘buddy’ device 100 are important design parameters for user convenience, the leak ‘buddy’ device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pipe leak remediating device comprising:
a top body portion;
a bottom body portion;
at least one gasket;
at least one drain; and
at least one hook and latch fastener;
wherein said top body portion fastenable to said bottom body portion with said at least one hook and latch fastener to form a cylindrical opening therethrough;
wherein said cylindrical opening surrounding a leaking pipe;
wherein said at least one gasket seals at least said bottom body portion around a portion of the leaking pipe; and
further wherein said top body portion fastened to said bottom body portion redirects water from the leaking pipe to said at least one drain.

2. The pipe leak remediating device of claim 1 further comprising at least one hose attachment connected to said at least one drain for directing water to another utility drain.

3. The pipe leak remediating device of claim 2, wherein said top body portion and said bottom body portion having a material made of plastic.

4. The pipe leak remediating device of claim 3, wherein said fastened said top body portion and said bottom body portion having a pressure threshold of 150 PSI.

5. The pipe leak remediating device of claim 4, wherein said fastened said top body portion and said bottom body portion having a temperature threshold of 250 degrees Fahrenheit.

6. The pipe leak remediating device of claim 3, wherein said fastened said top body portion and said bottom body portion having a form of a rectangular prism.

7. The pipe leak remediating device of claim 6, wherein said at least one gasket lining at least a top edge of said bottom body portion.

8. The pipe leak remediating device of claim 7, wherein said at least one gasket having a water-resistant rubber material.

9. The pipe leak remediating device of claim 3, wherein said at least one hook and latch fastener is a hook and loop strap.

10. The pipe leak remediating device of claim 3, wherein said at least one hook and latch fastener is a metal lock mechanism.

11. A pipe leak remediating device comprising:
a top body portion;
a bottom body portion;
a first gasket;
a second gasket;
at least one device drain;
at least a pair of hook and latch fasteners; and
at least one hose attachment;
wherein said top body portion fastenable to said bottom body portion with said at least a pair of hook and latch fasteners to form a cylindrical opening therethrough;
wherein said cylindrical opening surrounding a leaking pipe;
wherein said first gasket and said second gasket seal said top body portion and said bottom body portion around the leaking pipe;
wherein said top body portion sealed to said bottom body portion redirects water from the leaking pipe to said at least one device drain;
wherein said at least one hose attachment connected to said at least one device drain for directing water to another utility drain;
wherein said first gasket lining at least a top edge of said bottom body portion; and
further wherein said second gasket lining at least a bottom edge of said top body portion.

12. The pipe leak remediating device of claim 11, wherein said top body portion and said bottom body portion having a material made of plastic.

13. The pipe leak remediating device of claim 11, wherein said sealed said top body portion and said bottom body portion having a form of a rectangular prism.

14. The pipe leak remediating device of claim 11, wherein said first gasket and said second gasket having a water-resistant rubber material.

15. The pipe leak remediating device of claim 11, wherein said at least a pair of hook and latch fasteners are hook and loop straps.

16. The pipe leak remediating device of claim 11, wherein said at least a pair of hook and latch fasteners are metal lock mechanisms.

17. A method for remediating a pipe leak, the method comprising the steps of:
providing a top body portion, a bottom body portion, at least one gasket, at least one device drain, at least a pair of hook and latch fasteners, and at least one hose attachment;
fastening said top body portion to said bottom body portion with said at least a pair of hook and latch fasteners to form a cylindrical opening therethrough, wherein said cylindrical opening surrounding a leaking pipe;
sealing said at least one gasket around at least a portion of the leaking pipe;
redirecting water of the fastened said top body portion and said bottom body portion from the leaking pipe to said at least one device drain;
connecting said at least one hose attachment to said at least one device drain; and
directing water from said at least one hose attachment to another utility drain.

18. The method for remediating a pipe leak of claim 17, wherein said at least one gasket lining at least a top edge of said bottom body portion.

19. The method for remediating a pipe leak of claim 18 further comprising at least another gasket, wherein said at least another gasket lining at least a bottom edge of said top body portion.

20. The method for remediating a pipe leak of claim 18, wherein said at least a pair of hook and latch fasteners are hook and loop straps.
